(19) United States
(12) Patent Application Publication
(10) Pub. No.: US 2013/0005843 A1
(43) Pub. Date: Jan. 3, 2013

(54) Self-adhesive silicone rubber compositions and articles comprising same

(76) Inventor: K.C. Ricky Yeung, Tsuen Wan (HK)

(21) Appl. No.: 13/135,293

(22) Filed: Jun. 30, 2011

(51) Int. Cl. C09J 183/04

(52) U.S. Cl. 521/134; 525/477

(57) ABSTRACT

A self-adhesive silicone rubber composition includes a silicone rubber forming base and at least one adhesive agent mixed in the silicone rubber forming base prior to curing of the silicone rubber forming base.

### FIELD

The disclosure generally relates to self-adhesive silicone rubber compositions and more particularly, to self-adhesive articles having an adhesive surface including self-adhesive silicone rubber. More specifically, although not solely limited thereto, the disclosure relates to self-adhesive pads having a self-adhesive surface comprising self-adhesive silicone rubber and which are re-usable or re-attachable and can be removed from an adhering surface with no or minimal residue for repeated use.

### BACKGROUND

Silicones are silicon-containing polymers or pre-polymers that can be cured or cross-linked to form a higher molecular weight silicon-containing polymer. Silicones include silicon together with carbon, hydrogen, oxygen and sometimes other chemical elements. Silicones are inert and synthetic compounds with a wide variety of forms and uses. Silicone rubber is one common form of silicones and is typically heat-resistant and rubber-like and may be used as an adhesive.

Silicones are also known as polymerized siloxanes or polysiloxanes. Some non-limiting examples of silicone include polydimethylsiloxane, polymethylhydrosiloxane, fluorosilicones, phenylmethyl-dimethyl silicones and the like. Silicones have the chemical formula —[Si(R)₂—O]ₙ— where R is one or more organic groups such as methyl, ethyl and phenyl and n refers to the number of the repeating units in the backbone of the silicone polymer. In some embodiments, organic side groups can be used to link two or more —Si—O— backbones together. By varying the —Si—O— chain lengths, side groups and crosslinking, silicones can be synthesized with a wide variety of properties and compositions. They can vary in consistency from liquid to gel to rubber to hard plastic. The most common siloxane is linear polydimethylsiloxane (PDMS), a silicone oil. The second largest group of silicone materials is based on silicone resins, which are formed by branched and cage-like oligosiloxanes.

Self-adhesive silicone rubber has many useful applications. For example, silicone rubber can be applied as an adhesive layer on a memo pad, a note pad or a story board so that the pad or board can temporarily adhere to a surface such as a wall or display board and the adhesiveness of the silicone rubber layer can hold the pads on the surface against gravity. Self-adhesive silicone rubber of the re-adhesive or re-usable type is attractive for many applications because it can easily stick onto various surfaces without gluing.

While conventional self-adhesive silicone rubber compositions provide good and useful adhesive properties, the adhesiveness of such compositions is typically reduced over time. Therefore, it is desirable to improve the adhesive durability of self-adhesive silicone rubber compositions.

### SUMMARY

The disclosure is generally directed to a self-adhesive silicone rubber composition. An illustrative embodiment of the self-adhesive silicone rubber composition includes a silicone rubber forming base and at least one adhesive agent mixed in the silicone rubber forming base prior to curing of the silicone rubber forming base.

In some embodiments, the self-adhesive silicone rubber composition may include a cured mixture of silicone rubber forming base, at least one foaming agent and at least one adhesive agent.

The disclosure is further generally directed to a method of fabricating a self-adhesive silicone rubber composition. An illustrative embodiment of the method includes providing a silicone rubber forming base, mixing an adhesive with the silicone rubber forming base and curing the silicone rubber forming base.

### BRIEF DESCRIPTION OF THE DRAWINGS

The disclosure will now be made, by way of example, with reference to the accompanying drawings, in which:

FIG. 1 is an exemplary methyl siloxane resin with a reticulate structure which is suitable for fabrication of an illustrative embodiment of self-adhesive silicone rubber composition according to the disclosure;

FIG. 2 is an exemplary structure of an organo-hydropolysiloxane which is suitable for fabrication of an illustrative embodiment of self-adhesive silicone rubber composition according to the disclosure;

FIG. 3 is a two-phase diagram of an exemplary silicone pressure-sensitive adhesive (“silicone PSA”) which is suitable for fabrication of an illustrative embodiment of self-adhesive silicone rubber composition according to the disclosure;

FIG. 4 is a block diagram showing exemplary procedures of applying silicone PSAs in fabrication of an illustrative embodiment of a self-adhesive silicone rubber composition according to the disclosure; and

FIG. 5 is a perspective view of a T-peel specimen which can be used to implement a peel test for testing the peel strength of an adhesive agent used in fabrication of the self-adhesive silicone rubber composition.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

The disclosure is generally directed to self-adhesive silicone rubber compositions which may include at least one adhesive agent mixed with a silicone rubber forming base.

In some embodiments, the silicone rubber forming base may be non-porous.

In some embodiments, the adhesive agent may include a silicone-based adhesive agent such as silicone pressure-sensitive adhesive (Silicone PSA) or a silicone varnish such as a polyorganosiloxane, for example and without limitation.

The adhesive agent or agents may be distributed within the silicone rubber forming base.

The adhesive agent or agents may be retained within the cured silicone rubber forming base for example and without limitation by adding at least one foaming agent into the silicone rubber forming base before curing of the silicone rubber forming base.

As an example, the self-adhesive silicone rubber composition may include a cured mixture of silicone rubber forming base, at least one foaming agent and at least one adhesive agent.

In some embodiments, the foaming agents may include Toshiba NE800 which can be obtained from the Toshiba Corp. of Tokyo, Japan.

For example and without limitation, the foaming agent may react during curing of the silicone rubber forming base to cause retention or trapping of adhesive agents within the silicone rubber forming base.

Accordingly, a self-adhesive silicone rubber composition having high adhesive durability may be obtained by mixing substances for forming a silicone rubber forming base with adhesive agents and foaming agents.

For example and without limitation, the silicone rubber forming base may be prepared by mixing, reacting and compression molding or injection molding feedstocks which include a dimethylvinyl siloxane silica gel, a methylsiloxane resin and a cross-linking agent.

The silicone rubber forming base may include dimethylvinyl siloxane silica gel, a methylsiloxane resin and a peroxide cross-linking agent or a cross-linking agent including a platinum catalyst and an organo-hydropolysiloxane. The dimethylvinyl siloxane silica gel may have a high polymerization degree.

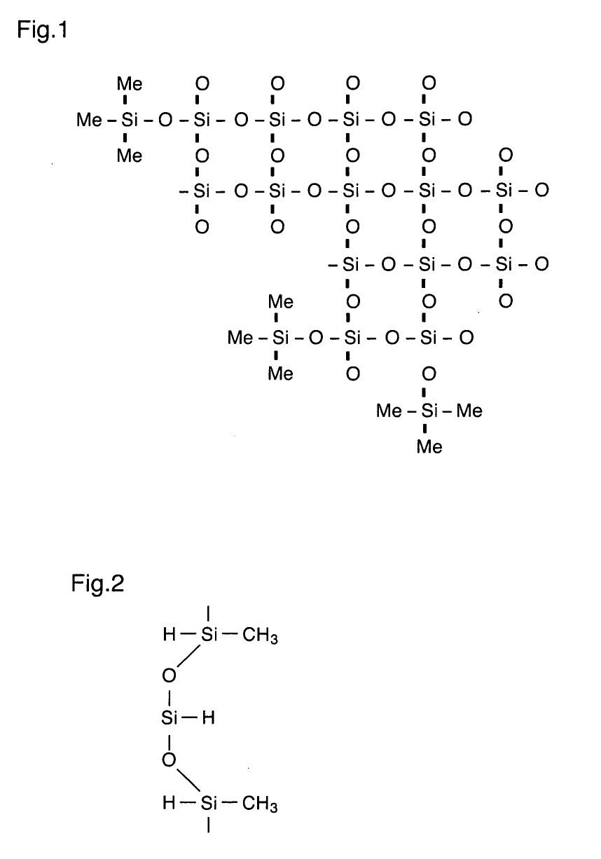

The methylsiloxane resins used in fabrication of the silicone rubber forming base may be commercially-available. In some embodiments, methysiloxane resins with a reticulate structure as shown in FIG. 1 may be used in fabrication of the silicone rubber forming base.

The peroxide cross-linking agent which is used in fabrication of the silicone rubber forming base may include benzoyl peroxide, di-(2,4-dichlorobenzoyl)peroxide, dicumyl peroxide, di-tert-butyl peroxide, p-monochlorobutyl peroxide, 2,5-dimethyl-2,5-di-tert butylperoxy hexane, di-tert-butylperoxy peroxide, 2,5-dimethyl-2,5-bis(tert-butylperoxy)hexane and tert-butylcumyl peroxide. An exemplary cross-linking agent is 2,5-dimethyl-2,5-di-tert-butylperoxy hexane. Other suitable cross-linking agents include commercially-available cross-linking agents with trade names C-8, C-8A and C-8B and available from the Shin-Etsu Silicone Corp. of Japan. The cross-linking agent may be used in a quantity of from about 0.3% to about 4% by weight based on the weight of other feed stocks.

Examples of Pt-catalysts which are suitable for fabrication of the silicone rubber base include but are not limited to platinum black, chloroplatinic acid, platinum tetrachloride, a complex of chloroplatinic acid-olefins, a complex of chloroplatinic acid-methylvinyl siloxane and the like.

Examples of organo-hydropolysiloxane cross-linking agents which are suitable for fabrication of the silicone rubber forming base include but are not limited to trimethylsiloxy-terminated methylhydropolysiloxane, trimethylsiloxy-terminated dimethylsiloxane-methylhydrosiloxane copolymer and dimethylphenylsiloxy-terminated methylphenylsiloxane methylhydrosiloxane copolymer.

The organo-hydropolysiloxanes may have the structure which is shown in FIG. 2. The process for preparing the silicone rubber forming base may be as follows:

dimethylvinyl siloxane silica gel+peroxide+methylsiloxane resin silicone rubber forming base Reaction route A:

dimethylvinyl siloxane silica gel+organo-hydropolysiloxane+methylsiloxane resin^{Pt}→silicone rubber forming base Reaction route B:

The self adhesive silicone rubber may be obtained by molding the conventional silicone rubber forming base and a cross-linking agent, an adhesive agent and a foaming agent, according to one of the methods set forth herein above, followed by baking of the molded product.

A compression molding method of molding the product may be carried out by conducting a common oil press under a molding pressure of about 150˜220 tons. The molding die may be locked at a temperature of about 120˜280 degrees C. The locking time of the die may be about 200˜220 seconds depending on different yardage of the die for molding the formulation through reaction.

An injection molding method of molding the product may be carried out by using an injection molding machine under a pressure of about 20˜200 kg at a temperature of about 150˜280 degrees C. for about 100˜1000 seconds.

A hot air curing method of fabricating the product may be carried out by kneading the feedstocks with multiple roll wheels and then transferring the kneaded blend into an oven at about 100˜300 degrees C. for about 100˜600 seconds.

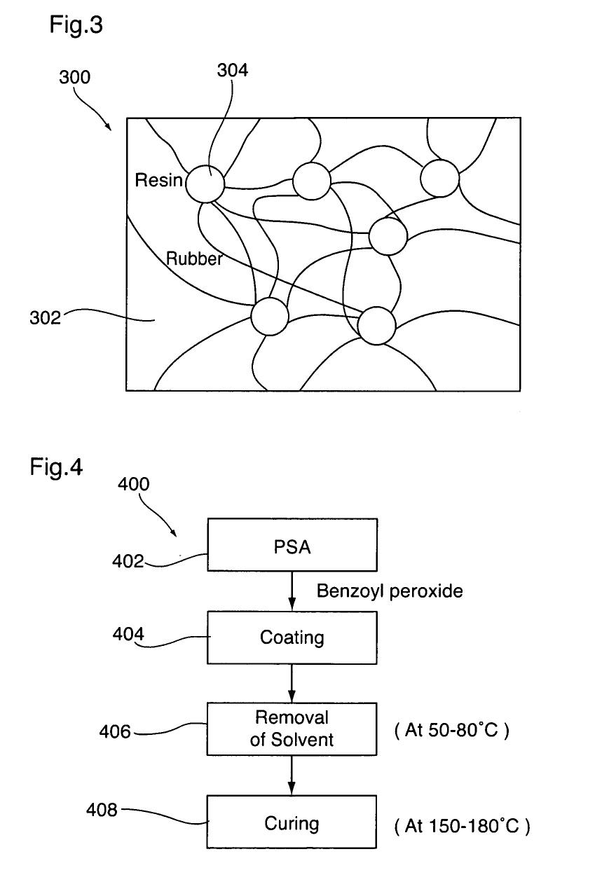

In some embodiments, the adhesive agents suitable for fabrication of the silicone rubber forming base may include silicone pressure sensitive adhesive (“Silicone PSA”). As illustrated in the two-phase diagram of silicone PSA 300 in FIG. 3, the silicone PSA 300 may include silicone rubber 302 and silicone resin 304 as two main components. The compositions of silicone PSA 300 may include 100 weight part silicone rubber 302, 50˜150 weight part silicone resin 304 and a necessary quantity of catalyst in about 100˜300 weight part.

Silicone PSA has broad operating temperature (from about −65 degrees C. to about 260 degrees C.), good electrical insulating properties, water or moisture resistance, weather resistance and drug resistance. Silicone PSA shows good adhesion to metals, glass, paper, cloth, rubber, etc. Moreover, silicone PSA can also be used in food or medical industry.

FIG. 4 shows a possible manner of applying silicone PSA. In block 402, about 80 weight parts % of silicone PSA are mixed with about 20 weight parts % of benzoyl peroxide. In block 404, the mixture of desired thickness is coated onto the base material. In block 406, the solvent is removed at about 50˜80 degrees C. In block 408, the silicone rubber composition is cured at about 150˜180 degrees C.

Four exemplary cure mechanisms for silicone adhesives include:

### (1). Peroxide Cure

Peroxide comprising sulfur (e.g. KR-101-10, KR-120, etc. obtainable from Shin-Etsu Silicone

Taiwan Co. Ltd)

Si—CH₃^{ROOR}→Si—CH₂—CH₂—Si+2ROH

### 2. Platinum Cure

Platinum (e.g. KR-820, X-40-3004A etc. obtainable from Shin-Etsu Silicone Taiwan Co. Ltd)

Si—CH═CH₂+H—Si^{Pt}→Si—CH₂—CH₂—Si

(3). Dehydrogenation (e.g. KR-105 Obtainable from Shin-Etsu Silicone Taiwan Co. Ltd)

Si—OH+H—Si^{Ti}→Si—O—Si+H₂

### (4). Moisture Cure

Si—ONC(CH₃)(C₂H₅)^{H2O}→Si—O—Si+2HNOC(CH₃)(C₂H₅)

Peroxide cure and platinum cure are two more commonly used curing mechanisms for silicone adhesive. Both peroxide cure and platinum cure are suitable curing mechanism for curing the silicone rubber forming base according to the disclosure. Each of the cure mechanisms has its advantages and disadvantages which are summarized in Table I below.

TABLE I

| Curing Mechanism | Peroxide Cure | Platinum Cure |
|---|---|---|
| Characteristic | Can be used over long | Can be used over long |
| | period of time | period of time |
| | Peroxide catalyst is not | Platinum catalyst is |
| | easily poisoned | easily poisoned |
| | Side product is | No side product is |
| | formed due to | formed during reaction |
| | decomposition | No pre-drying is required |
| | of peroxide | for the solvent |
| | Pre-drying is required | Cured at |
| | for the solvent | lower temperature |
| | Cured at | (80~130 degrees C.) |
| | higher temperature | Can also be applied on |
| | (150~180 degrees C.) | poor heat-resistance |
| | Can only be applied on | silicone base material |
| | good heat-resistance | KR-820, X-40-3004A |
| | silicone base material | obtainable from |
| Examples | KR-100, KR-101-10, | Shin-Etsu Silicone |
| | KR-120, KR-130 | Taiwan Co. Ltd |
| | obtainable from | |
| | Shin-Etsu Silicone | |
| | Taiwan Co. Ltd | |

Peroxide cure has several advantages over platinum cure. For example, peroxide cure can be used in a long time and the peroxide catalyst is not easily poisoned.

Peroxide cure also has several disadvantages over platinum cure. For example, side product may be formed due to decomposition of peroxide; pre-drying is required for the solvent; high curing temperature; and can only be applied on good heat-resistance silicone base material.

The disclosure will be further understood by consideration of the following examples.

### EXAMPLE 1

100 weight parts of dimethylvinyl siloxane silica gel, 2 weight parts of C-8 cross-linking agent obtainable from Shin-Etsu Silicone Taiwan Co. Ltd., 10 weight parts of methylsiloxane resin and 10 weight parts adhesive agent were mixed uniformly and then press-vulcanized by using a conventional compression molding method at 165 degrees C. for 10 minutes and baked at 200 degrees C. for 4 hours to obtain an illustrative embodiment of the self-adhesive silicone rubber composition of the disclosure.

### EXAMPLE 2

100 weight parts of dimethylvinyl siloxane silica gel, 0.5 weight parts of C-8A cross-linking agent obtainable from Shin-Etsu Silicone Taiwan Co. Ltd., 10 weight parts of methylsiloxane resin and 10 weight parts adhesive agent were mixed uniformly and then press-vulcanized by using a conventional compression molding method at 165 degrees C. for 10 minutes and baked at 200 degrees C. for 4 hours to obtain an illustrative embodiment of the self-adhesive silicone rubber composition of the disclosure.

### EXAMPLE 3

100 weight parts of dimethylvinyl siloxane silica gel, 1 weight part of C-8B cross-linking agent obtainable from Shin-Etsu Silicone Taiwan Co. Ltd., 10 weight parts of methylsiloxane resin and 10 weight parts adhesive agent were mixed uniformly and then press-vulcanized by using a conventional compression molding method at 165 degrees C. for 10 minutes and baked at 200 degrees C. for 4 hours to obtain an illustrative embodiment of the self-adhesive silicone rubber composition of the disclosure.

### EXAMPLE 4

100 weight parts of dimethylvinyl siloxane silica gel, 3 weight parts of C-8 cross-linking agent obtainable from Shin-Etsu Silicone Taiwan Co. Ltd., 10 weight parts of methylsiloxane resin and 10 weight parts adhesive agent were mixed uniformly and then press-vulcanized by using a conventional compression molding method at 165 degrees C. for 5 minutes and baked at 200 degrees C. for 4 hours to obtain an illustrative embodiment of the self-adhesive silicone rubber composition of the disclosure.

### EXAMPLE 5

100 weight parts of dimethylvinyl siloxane silica gel, 2 weight parts of C-8 cross-linking agent obtainable from Shin-Etsu Silicone Taiwan Co. Ltd., 10 weight parts of methylsiloxane resin and 10 weight parts adhesive agent were mixed uniformly and then press-vulcanized by using a conventional injection molding method at 165 degrees C. for 10 minutes and baked at 200 degrees C. for 4 hours to obtain an illustrative embodiment of the self-adhesive silicone rubber composition of the disclosure.

### EXAMPLE 6

100 weight parts of dimethylvinyl siloxane silica gel, 2 weight parts of C-8 cross-linking agent obtainable from Shin-Etsu Silicone Taiwan Co. Ltd., 10 weight parts of methylsiloxane resin and 10 weight parts adhesive agent were mixed uniformly and then press-vulcanized by using a conventional hot-air curing method at 165 degrees C. for 10 minutes and baked at 200 degrees C. for 4 hours to obtain an illustrative embodiment of the self-adhesive silicone rubber composition of the disclosure.

### EXAMPLE 7

100 weight parts of dimethylvinyl siloxane silica gel, 1.5 weight parts of C-3 cross-linking agent obtainable from Shin-Etsu Silicone Taiwan Co. Ltd., 10 weight parts of methylsiloxane resin and 10 weight parts adhesive agent were mixed uniformly and then press-vulcanized by using a conventional hot-air curing method at 155 degrees C. for 10 minutes and baked at 200 degrees C. for 4 hours to obtain an illustrative embodiment of the self-adhesive silicone rubber composition of the disclosure.

### EXAMPLE 8

100 weight parts of dimethylvinyl siloxane silica gel, 0.5 weight parts of organo-hydropolysiloxane and Pt, 2.5 weight parts of C-19 (containing HCC compound inhibitor having a structure formula R1C≡CR2, wherein R1 and R2 are reactive free radicals, obtained from Japan Shin-Etsu Silicone Corp.), 10 weight parts of methylsiloxane resin and 10 weight parts adhesive agent were mixed uniformly and then press-vulcanized by using a conventional compression molding method at 120 degrees C. for 10 minutes and baked at 200 degrees C. for 4 hours to obtain an illustrative embodiment of the self-adhesive silicone rubber composition of the disclosure.

Unexpectedly, the self-adhesive silicone rubber compositions of the present disclosure have very strong adhesive properties. Furthermore, the self-adhesive silicone rubber compositions of the present disclosure have different superior performances depending on the different hardness of feedstocks selected as those shown in Table 2 below (based on Shore A 30 degree of hardness).

TABLE 2

| Experimental Item | Specification |
|---|---|
| Specific gravity (23 ± 2° C.) | 1.05-1.15 |
| Hardness (Hardometer A) | 30 ± 10 |
| Tensile strength (MPa) | ≧1 |
| Elongation (%) | ≧400 |
| Tearing strength (Crescent A KN/m) | ≧2 |

In some embodiments, commercially-available adhesive agents used in Examples 1-8 above may include KRT-001 which is available from Shin-Etsu Silicone Taiwan Co. Ltd. In some embodiments, foaming agent can be added to the mixture in each of Examples 1-8 to further improve adhesiveness of the silicon rubber product. In some embodiments, the foaming agents may include Toshiba NE800.

The self-adhesive silicone rubber compositions of the present disclosure can be fabricated as a variety of objects including but not limited to pads and sheets according to conventional molding techniques which are known by those skilled in the art. The self-adhesive silicone rubber compositions can repeatedly adhere to a clean surface such as wood, metal or plastic and can be removed from the surface without leaving adhesive residue on the surface. The compositions exhibit prolonged adhesive durability as the adhesive strength of the compositions substantially remains through repeated adhesion of the compositions to surfaces and removal of the compositions from the surfaces.

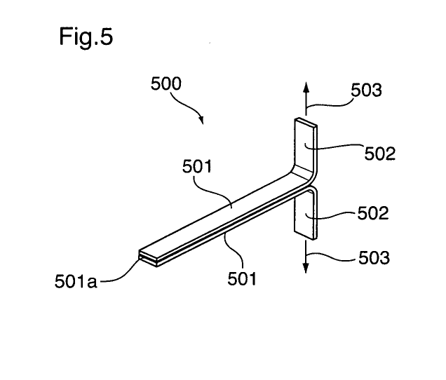

Referring next to FIG. 5, a T-peel specimen 500 which can be used to implement a peel test for testing the peel strength of an adhesive agent used in fabrication of the self-adhesive silicone rubber composition is shown. The T-peel specimen 500 may include a pair of bonded specimen segments 501 which are bonded to each other with an adhesive agent along a bond line 501a. A pair of free specimen segments 502 extend away from the bond line 501a. Accordingly, the free specimen segments 502 can be pulled away from each other along the arrows 503 to assess the peel strength of the adhesive agent at the bond line 501a between the bonded specimen segments 501. Peel strength may be reported as high, low and average loads sustained while separating the bonded specimen segments 501. Peel values may be recorded in pounds per square inch of width of the bonded specimen segments 501.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A self-adhesive silicone rubber composition, comprising:
a silicone rubber forming base; and
at least one adhesive agent mixed in said silicone rubber forming base prior to curing of said silicone rubber forming base.

2. The self-adhesive silicone rubber composition of claim 1 further comprising at least one foaming agent mixed in said silicone rubber forming base prior to curing of said silicone rubber forming base.

3. The self-adhesive silicone rubber composition of claim 1 wherein said at least one adhesive agent comprises at least one silicone-based adhesive agent.

4. The self-adhesive silicone rubber composition of claim 3 wherein said at least one silicone-based adhesive agent comprises silicone pressure-sensitive adhesive.

5. The self-adhesive silicone rubber composition of claim 4 wherein said silicone pressure-sensitive adhesive comprises about 100 weight part silicone rubber, about 50˜150 weight part silicone resin and about 100˜300 weight part catalyst.

6. The self-adhesive silicone rubber composition of claim 3 wherein said at least one silicone-based adhesive agent comprises a silicone varnish.

7. The self-adhesive silicone rubber composition of claim 1 wherein said silicone rubber forming base comprises a dimethylvinyl siloxane silica gel, a methylsiloxane resin and a cross-linking agent.

8. The self-adhesive silicone rubber composition of claim 1 wherein said silicone rubber forming base is non-porous.

9. A self-adhesive silicone rubber composition, comprising:
a cured mixture of silicone rubber forming base, at least one foaming agent and at least one adhesive agent.

10. The self-adhesive silicone rubber composition of claim 9 wherein said at least one adhesive agent comprises at least one silicone-based adhesive agent.

11. The self-adhesive silicone rubber composition of claim 10 wherein said at least one silicone-based adhesive agent comprises silicone pressure-sensitive adhesive.

12. The self-adhesive silicone rubber composition of claim 11 wherein said silicone pressure-sensitive adhesive comprises about 100 weight part silicone rubber, about 50˜150 weight part silicone resin and a catalyst in about 100˜300 weight part.

13. The self-adhesive silicone rubber composition of claim 10 wherein said at least one silicone-based adhesive agent comprises a silicone varnish.

14. The self-adhesive silicone rubber composition of claim 9 wherein said silicone rubber forming base comprises a dimethylvinyl siloxane silica gel, a methylsiloxane resin and a cross-linking agent.

15. The self-adhesive silicone rubber composition of claim 9 wherein said silicone rubber forming base is non-porous.

16. A method of forming the self-adhesive silicone rubber composition of claim 1 comprising:
mixing an adhesive with said silicone rubber forming base; and
curing said silicone rubber forming base to form said self-adhesive silicone rubber composition.

17. The method of claim 16 further comprising mixing a foaming agent with said silicone rubber forming base prior to curing said mixture.

18. The method of claim 16 wherein curing said mixture comprises curing said mixture using a selected one of a peroxide curing process, a platinum curing process, dehydrogenation curing process and a moisture curing process.

19. The method of claim 16 wherein said mixing an adhesive with said silicone rubber forming base comprises mixing a silicone pressure-sensitive adhesive with said silicone rubber forming base.

20. The method of claim 19 wherein said mixing a silicone pressure-sensitive adhesive with said silicon rubber forming base comprises mixing a silicone pressure-sensitive adhesive comprising about 100 weight part silicone rubber, about 50˜150 weight part silicone resin and about 100˜300 weight part catalyst with said silicone rubber forming base.

21. A self-adhesive article comprising the self-adhesive silicone rubber composition of claim 1, wherein said article is in the form of a pad, sheet or board and comprises an adhesive surface.

22. The self-adhesive article of claim 21, where said adhesive surface is re-usable or re-attachable and has an adhesive shelf-life of 3 years or more.

23. The self-adhesive article of claim 21, where said adhesive surface can be removed from an adhering surface without leaving adhesive residue for repeated use.

24. The self-adhesive silicone rubber composition of claim 1, wherein said adhesive agent is distributed within said silicone rubber forming base.

25. A self-adhesive silicone rubber composition, consisting essentially of a mixture of silicone rubber forming base, at least one foaming agent and at least one adhesive agent.

26. A method of forming the self-adhesive article of claim 21, comprising molding an adhesive composition to form said article, wherein said adhesive composition comprises a cured mixture of silicone rubber forming base and at least one adhesive agent.
